(19) United States
(12) Patent Application Publication
(10) Pub. No.: US 2004/0095612 A1
(43) Pub. Date: May 20, 2004

(54) Facsimile machine and facsimile transmission method

(75) Inventors: Masashi Eguchi, Joyo-shi (JP); Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/684,370

(22) Filed: Oct. 15, 2003

(30) Foreign Application Priority Data
Nov. 18, 2002 (JP) 2002-334056
Nov. 18, 2002 (JP) 2002-334057

(51) Int. Cl. H04N 1/00

(52) U.S. Cl. 358/402; 358/400

(57) ABSTRACT

To provide a facsimile machine which can reduce a period of time from the start of an original document scanning process until an end of a transmission of the electronic mailing of image data, by carrying out an electronic mail transmission process in parallel with an original document scanning process (parallel process). Approximately in parallel with the scanning of a first page P1 of the original documents, a second page P2 of the original documents, and a third page P3 of the original documents, corresponding image data P1D, P2D and P3D are generated, and further in parallel, packets as electronic mail data D1 through D9 are generated. When the generation of the electronic mail data D1 is completed, the electronic mail transmission data MD1 is transmitted, and then, the electronic mail transmission data MD2 through MD9 are transmitted serially according to each of the corresponding electronic mail data D2 through D9.

### FIELD OF THE INVENTION

The present invention relates to a facsimile machine, and more specifically to an Internet facsimile machine which can transmit image data as electronic mail via a communication network such as the Internet or a Local Area Network (LAN).

### DESCRIPTION OF THE RELATED ART

A conventional Internet facsimile machine (hereinafter referred to as a “facsimile machine”) scans an original document to be transmitted, and generates encoded image data (image data for facsimile communication, hereinafter referred to as “image data”) encoded by an encoding method, such as a Modified Huffman (MH), Modified Read (MR), or Modified Modified Read (MMR) method. Then, after the generation process of the image data is completed, the facsimile machine converts the image data into electronic mail data to be transmitted in the form of electronic mail (for example, image format of Tagged Image File Format (TIFF)). After the conversion process is completed, the facsimile machine transmits the electronic mail.

Using such a conventional facsimile machine, a period of time from the original document scanning process until the start of the transmission of the electronic mail, and a period of time until the completion of the transmission of the electronic mail are a period of time which can be calculated approximately by adding each of processing times. Further, the image data of the TIFF format (TIFF image data) is binary data, and when transmitting an electronic mail, the TIFF image data is converted once into text data and transmitted such that the electronic mail arrives reliably at the destination. A binary/text conversion (encoding) from the binary data into the text data can be carried out by using base64 of Multipurpose Internet Mail Extensions (MIME) or the like.

As described above, in the conventional facsimile machine where the processing in each stage is carried out serially, the period of time from the start of the original document scanning process until the start of the transmission of the electronic mail with the image data, and the period of time from the start of the original document scanning process until the end of the transmission of the electronic mail of the image data combine to become long due to each of the processing times being added approximately serially. As a result, a characteristic of electronic mail that the electronic mail can be transmitted promptly could not be utilized fully.

Moreover, when the connection failed to be established with the destination, or when a transmission error was detected, a response could not be made smoothly in such a circumstance, and confusion from the transmission could not be avoided.

### SUMMARY OF THE INVENTION

The present invention was made in consideration of such problems. An advantage of the present invention is that it provides a facsimile machine and a facsimile transmission method which can reduce the period of time from the start of the original document scanning process until the start of the transmission of the electronic mail with the image data, and the period of time from the start of the original document scanning process until the end of the transmission of the electronic mail with the image data, by carrying out the original document scanning process in parallel with a generation process of image data after the original document scanning process is started based on an electronic mail transmission instruction (electronic mail transmission operation), and by carrying out an electronic mail data generation process for serially converting image data obtained from the original document into electronic mail data for each packet and an electronic mail transmission process for serially transmitting the electronic mail data for each packet in parallel with the original document scanning process (parallel process).

Furthermore, another advantage of the present invention is that it provides a facsimile machine and a facsimile transmission method which can carry out the parallel processing smoothly by generating image data according to the receiving ability of the destination. Moreover, another advantage of the present invention is that it provides a facsimile machine and a facsimile transmission method which can carry out the parallel processing smoothly by holding the connection established with the destination when readiness of electronic mail data to be transmitted next is determined and it is determined that the data is not ready yet. Furthermore, another advantage of the present invention is that it provides a facsimile machine and a facsimile transmission method which can retroactively abandon the transmitted electronic mail data in the parallel processing (one electronic mail transmission process) during the period of time from the original document scanning process until the electronic mail transmission process of the image data by disconnecting a connection appropriately according to an instruction to stop the transmission.

Another advantage of the present invention is that it provides a facsimile machine and a facsimile transmission method which can reduce the period of time from the start of the original document scanning process until the end of the transmission of the electronic mail by carrying out parallel processing after the original document scanning process is started based on an electronic mail transmission instruction (electronic mail transmission operation), and which can carry out the process smoothly when a connection failed to be established with the destination in the transmission of the electronic mail by providing a notifying and selecting unit which notifies of such a fact and selects whether to continue or stop the transmission of the electronic mail. Further, in the parallel processing, the following processes are carried out in parallel with one another: the original document scanning process, the image data generation process for generating image data from the scanned original document, the electronic mail data generating process for serially converting the generated image data into the electronic mail data for each packet, and the electronic mail transmission process for serially transmitting the electronic mail data in the form of the electronic mail.

Furthermore, another advantage of the present invention is that it provides a facsimile machine and a facsimile transmission method which can carry out the process smoothly when a connection failed to be established by providing a notifying and selecting unit which notifies of a transmission error when the transmission error is detected in the transmission of an electronic mail and which selects either to continue or stop the transmission of the electronic mail. Another advantage of the present invention is that it provides a facsimile machine and a facsimile transmission method which can retroactively abandon the transmitted electronic mail data in the parallel processing during the period of time from the original document scanning process until the electronic mail transmission process of the image data (one electronic mail transmission process) by providing a transmission stopping unit which notifies of a fact that the transmission of the electronic mail cannot be continued and stops the transmission of the electronic mail when the contents of the transmission error corresponds to a state in which the transmission of the electronic mail cannot be continued.

According to the facsimile machine and the facsimile transmission method of the present invention, the original document scanning process is carried out in parallel with the image data generating process. In addition, the electronic mail data generating process for serially converting the image data obtained from the original document into the electronic mail data for each packet, and the electronic mail transmission process for serially transmitting the electronic mail data for each packet are carried out in parallel with the original document scanning process (parallel process). Therefore, the period of time from the start of the original document scanning process until the start of the transmission of the electronic mail, and the period of time from the start of the original document scanning process until the end of the transmission of the electronic mail can be reduced.

According to the facsimile machine and the facsimile transmission method of the present invention, the image data for the facsimile communication is generated according to the receiving ability of the destination. Therefore, the parallel process from the original document scanning process until the electronic mail transmission process can be carried out smoothly.

According to the facsimile machine and the facsimile transmission method of the present invention, the readiness of the electronic mail data to be transmitted next is determined, and when it is determined that the electronic mail data is not ready yet, a connection established with the destination is held. Therefore, a connection can be prevented from being disconnected during the transmission of the electronic mail, and the parallel process from the original document scanning process until the electronic mail transmission process can be carried out smoothly.

According to the facsimile machine and the facsimile transmission method of the present invention, the connection can be disconnected appropriately according to the instruction to stop the transmission in the serial electronic mail transmission. Therefore, in the parallel process from the original document scanning process until the transmission processing of the electronic mail (one electronic mail transmission process), the transmitted electronic mail data can be abandoned retroactively. As a result, the destination can be prevented from learning the data that was transmitted by mistake.

According to the facsimile machine and the facsimile transmission method of the present invention, when a connection failed to be established with the destination in the transmission of the electronic mail, such a fact is notified to allow an operator to select either to continue or to stop the transmission of the electronic mail. Therefore, an operation can be carried out smoothly even when a connection failed to be established with the destination in the transmission of the electronic mail.

According to the facsimile machine and the facsimile transmission method of the present invention, when a transmission error is detected in the transmission of the electronic mail, the contents of the transmission error is notified to allow an operator to select either to continue or stop the transmission of the electronic mail. Therefore, an operation can be carried out smoothly even when a transmission error is detected in the transmission of the electronic mail.

According to the facsimile machine and the facsimile transmission method of the present invention, when the contents of the transmission error corresponds to a state in which the transmission of the electronic mail cannot be continued, the fact that the transmission of the electronic mail cannot be continued is notified, and the transmission of the electronic mail is stopped. Therefore, an operation can be carried out smoothly even when a transmission error is detected in the transmission of the electronic mail. Moreover, in the parallel process from the original document scanning process until the electronic mail transmission process (one electronic mail transmission process), when the transmission of the electronic mail is stopped, the transmitted electronic mail data can be abandoned retroactively. As a result, the destination can be prevented from learning the data that was transmitted by a mistake.

### BRIEF DESCRIPTION OF THE DRAWINGS

FIG. 1 is a schematic view showing a configuration of a communication network connected with a facsimile machine according to an embodiment of the present invention.

FIG. 2 is a block diagram showing an example of an inner configuration of the facsimile machine according to an embodiment of the present invention.

FIG. 3 shows a timing of operations of the facsimile machine according to an embodiment of the present invention.

FIG. 4 is a flowchart showing an overview of an operational flow of the facsimile machine according to an embodiment of the present invention.

FIG. 5 is a flowchart showing an overview of a functional operation flow of the facsimile machine according to an embodiment of the present invention.

### DETAILED DESCRIPTION OF THE PREFERRED EMBODIMENTS

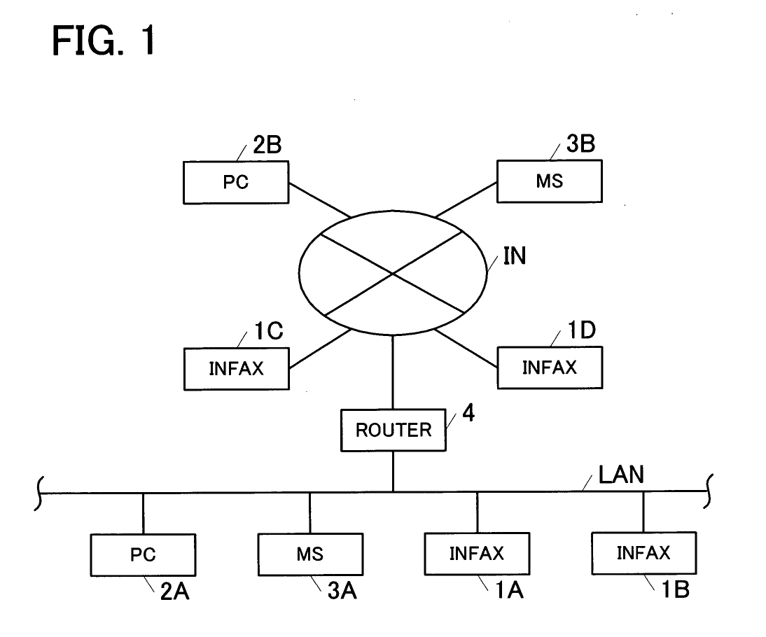

An embodiment of the present invention will be described with reference to the accompanying drawings. FIG. 1 is a schematic view showing a configuration of a communication network connected with a facsimile machine according to an embodiment of the present invention. Reference numerals 1A, 1B, 1C and 1D are facsimile machines (hereinafter referred to as the INFAX) of the present invention. Further, the INFAX 1A, 1B, 1C and 1D (in the following, when it is not necessary to distinguish between each INFAX, the INFAX 1A, 1B, 1C and 1D will be referred collectively as the INFAX 1) are of course usable as the conventional G3 facsimile machine using a Public Switched Telephone Network (PSTN). Thus, a connection established between the INFAX 1 and the PSTN is abbreviated in the drawing.

The INFAX 1A and 1B, a mail server (MS) 3A, a personal computer (PC) 2A or the like are connected to the LAN. These devices (INFAX 1A, 1B, PC2A, etc.) can reciprocally carry out a communication (transmission and reception) via the MS 3A by using an electronic mail. Moreover, the LAN is connected to the Internet IN via a router 4, and the INFAX 1C and 1D, a MS 3B, a PC 2B or the like are connected to the Internet IN in the same manner as the LAN. These devices (INFAX 1A, 1B, PC 2B, etc.) can reciprocally carry out communication via the MS 3B by using electronic mail. Furthermore, each of the devices that is connected to the LAN and each of the devices that is connected to the Internet IN can reciprocally carry out communication by using electronic mail via the MS 3A, the MS 3B, and the router 4.

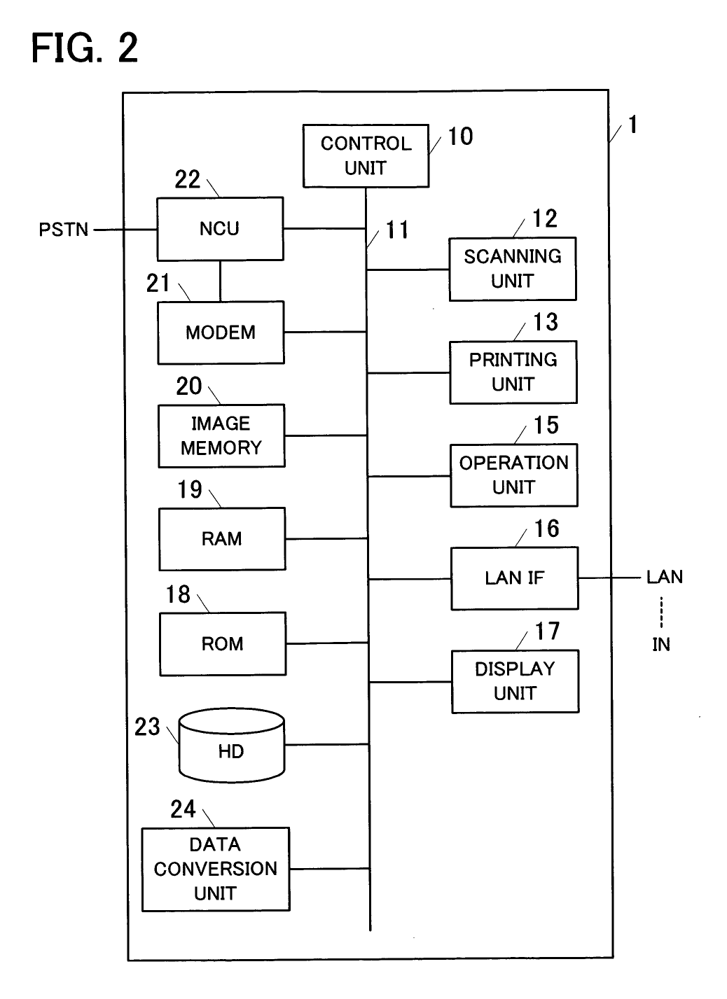

FIG. 2 is a block diagram showing an example of an inner configuration of the facsimile machine according to an embodiment of the present invention. The INFAX 1, which is the facsimile machine of the present invention, includes a control unit 10 that is formed from a Central Processing Unit (CPU). The control unit 10 is connected to a scanning unit 12, a printing unit 13, an operation unit 15, a LAN interface (LANIF) 16, a display unit 17, a Read Only Memory (ROM) 18, a Random Access Memory (RAM) 19, an image memory 20, a modem 21, a Network Control Unit (NCU) 22, a Hard Disk (HD) 23, and a data conversion unit 24 via a bus 11. The control unit 10 controls each of the above-mentioned parts, and executes various functions in accordance with computer programs that are stored in the ROM 18 in advance. The control unit 10 executes various functions (for example, an image data generating function, a data converting function, an identifying function, a serial transmission function, a determining function, a connection holding function, and a connection stopping function) in the present invention with other parts or independently.

The scanning unit 12 scans an original document to be transmitted by a scanner using a Charge Coupled Device (CCD) or the like. The scanned data is converted into binary of black and white, and the encoded image data is generated by a Coder and Decoder (CODEC) (not shown in the drawings) and output. Then, the image data is stored into the image memory 20 formed from a Dynamic RAM (DRAM) or the like via the bus 11. As an encoding method for such a case, the encoding methods such as MH, MR, and MMR methods are defined in a standard of facsimile communication. Further, an encoding unit such as a CODEC can be provided separately from the scanning unit 12, and the encoding process can be carried out. Either one of a Flat Bed Scanner (FBS) and an Auto Document Feeder (ADF) can be used for the scanning of the original document. The printing unit 13 is an electro-photographic typed printing device or the like, and prints out as a hardcopy, image data received by a facsimile communication from another facsimile machine, or image data received by a communication network.

The operation unit 15 includes letter keys, a ten-key numeric pad, speed-dial keys, one-touch dial keys, and various function keys or the like that are necessary for operating the INFAX 1, such that the operation unit 15 can function as an input unit. Further, by forming the display unit 14 as a touch panel, a part or all of the various keys of the operation unit 15 can be substituted.

The LANIF 16 is an interface for the INFAX 1 (for example, the INFAX 1A) to carry out communication with another INFAX 1 (1B), the PC (2A), or the MS (3A) via the LAN. Moreover, the LANIF 16 is also connected to the Internet IN via a router (4), and can carry out communication with another INFAX 1 (1C, 1D), the PC (2B), or the MS (3B).

The display unit 17 is a displaying device such as a Liquid Crystal Display (LCD) or the like. The display unit 17 displays an operational state of the INFAX 1, and also displays image data of an original document to be transmitted, received image data, image data stored in the HD 23 or the like.

The RAM 19 stores temporary data generated when a computer program is executed by the control unit 10. For example, the RAM 19 is formed from a DRAM, flash memory or the like. The HD 23 is a memory having a large capacity, and stores image data, electronic mail addresses, facsimile numbers, name of destinations, facsimile numbers corresponding to the speed-dial keys, telephone numbers or the like.

The modem 21 is formed from a facsimile modem which can carry out a facsimile communication. The NCU 22 is directly connected to the modem 21. The NCU 22 establishes a connection with the PSTN or disconnects the connection. When necessary, the NCU 22 connects the modem 21 to the PSTN, and controls facsimile communication between the INFAX 1 and a remote facsimile machine (a conventional facsimile machine not using electronic mail).

The data conversion unit 24 converts the image data of an original document encoded in accordance with the above-mentioned facsimile communication standard (FAX image data) into image format of TIFF, a Portable Document Format (PDF) or the like, such that the image data can be transmitted in the form of electronic mail. In the course of transmission, binary/text conversion (encoding) is carried out on the TIFF image format by using MIME base64 such that the binary data is converted into text data. Further, in the course of reception, the data conversion unit 24 can carry out conversion in the order that is the opposite of the conversion carried out at the transmission.

The data conversion unit 24 can include a function for generating an electronic mail header that is necessary for the transmission of the electronic mail. The electronic mail header includes information such as a transmission date and time of the electronic mail, the transmitter of the electronic mail, the destination of the electronic mail, and additional information related to the electronic mail message (for example, a title). Further, a code (IFAX), which indicates facsimile communication using the Internet IN, is appropriately included in the additional information.

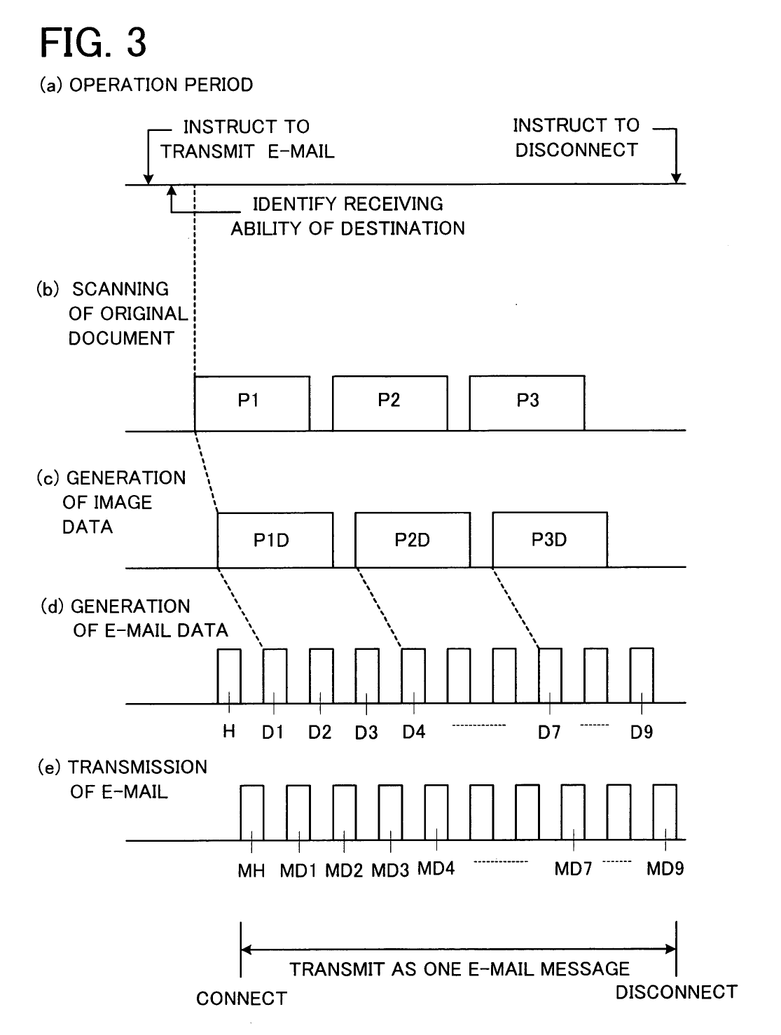

FIG. 3 shows the timing of operations of the facsimile machine according to an embodiment of the present invention. The horizontal lines show the elapse of time, and in the drawing, (a) shows the operation period in the transmission of the electronic mail, (b) shows the scanning state of the original document in the scanning unit 12, (c) shows the image data generation state in the scanning unit 12 or the like, (d) shows the electronic mail generation state in the data conversion unit 24 or the like, and (e) shows the transmission state of an electronic mail transmission via the LANIF 16.

In FIG. 3, (a) shows an example of the relationship between time and an electronic mail transmission instruction (acceptance of an instruction), an identification of the receiving ability of a destination (an identification operation), and a disconnection instruction, in the operation period of the transmission of the electronic mail. First, the setting of the original document to be transmitted, the configuration of the scanning condition of the scanning unit 12, the input of necessary items for the transmission of the electronic mail (for example, items that are necessary for forming the electronic mail header such as the electronic mail address of the destination) or the like are carried out in advance by the operation unit 15. Further, for the items with no changes, for example, the electronic mail address of the destination, such items can be registered with the HD 23 in advance, and can be invoked and selected when necessary. After the items that are necessary for the transmission of the electronic mail are input, and an electronic mail transmission instruction is input from the operation unit 15 (electronic mail transmission operation), the control unit 10 starts to control the operation of each part in accordance with the computer program that is embedded in the ROM 18 in advance, and the INFAX 1 starts to operate.

After the start of the operation, the receiving ability of the destination that is registered as existing data in the HD 23 is identified by corresponding with the destination (electronic mail address). Further, the receiving ability of the destination is preferably obtained and registered with the HD 23 in advance. However, when starting to transmit the electronic mail, the information can be obtained from the destination prior to the transmission of the electronic mail data by an appropriate identifying function or the like. At the completion of the transmission of the electronic mail (final stage of the operation period), the control unit 10 outputs a disconnection instruction, and the electronic mail transmission operation of the INFAX 1 ends.

In FIG. 3, (b) shows the scanning state of three pages of original documents by a scanner of the scanning unit 12 (original document scanning process). The scanning process for the first page P1 of the original documents, the second page P2 of the original documents, and the third page P3 of the original documents are shown. That is, as shown in the drawing, the original document scanning process is generally carried out by a unit of pages (for each page). The control unit 10 controls the operation of the scanning unit 12 by the instruction to start the transmission of the electronic mail, and the scanning unit 12 scans the original documents one page at a time by the scanner.

In FIG. 3, (c) shows the image data generation state for the scanned three pages of original documents (image data generation process). Reference numeral P1D shows the image data of the first page P1 of the original documents (generation state), P2D shows the image data of the second page P2 of the original documents (generation state), and P3D shows the image data of the third page of the original documents (generation state). For example, the scanning unit 12 generates image data that is encoded into binary of black and white from the scanned original document in parallel with the original document scanning process. The scanning unit 12 operates as the image data generating function that carries out the image data generation process with the control unit 10, and the generated image data is stored into the image memory 20.

Further, the data structure of the image data (image data for facsimile communication) is as described above, and for example, the image data is the encoded data that is converted into binary of black and white by encoding methods such as the MH, the MR, or the MMR methods. Furthermore, when identifying the receiving ability of the destination prior to the original document scanning process, the image data generating function generates the image data according to the identified receiving ability of the destination (receiving ability information). As a result, the image data can be formed more appropriately, and the transmission can be carried out more smoothly. Further, the receiving ability of the destination includes resolution, paper size or the like.

In FIG. 3, (d) shows the electronic mail data generation state for converting the image data that is formed for the three pages of original documents into electronic mail data (electronic mail data generation process). D1 through D3 show packets of electronic mail data that were converted from the image data P1D (generation state). D4 through D6 show packets of electronic mail data that were converted from the image data P2D (generation state). D7 through D9 show packets of electronic mail data that were converted from the image data P3D (generation state). That is, the image data are respectively divided into three packets, and electronic mail data are formed. The data conversion unit 24 operates as the electronic mail data generating function (data converting function) that executes the electronic mail data generation process with the control unit 10.

That is, the image data (P1D through P3D), which is formed in accordance with the receiving ability of the destination and stored into the image memory 20, are fetched serially for each appropriate packet (prescribed volume). Then, the image data are converted into the electronic mail data (D1 through D9) approximately in parallel with the original document scanning process. Further, prior to the generation of the electronic mail data (D1 through D9), an electronic mail header H is formed by a publicly known method. Further, the conversion format for this case is as described above. For example, the image data, which is encoded in binary of black and white, is converted into the image format of TIFF or PDF to be the electronic mail data which can be transmitted in the form of electronic mail.

In FIG. 3, (e) shows the electronic mail transmission state via the LANIF 16 (electronic mail transmission process), and shows that a part of the electronic mail is transmitted serially each time the electronic mail data (D1 through D9) are formed. Reference numeral MH shows an electronic mail transmission header, and MD1 through MD9 show electronic mail transmission data. The electronic mail header MH corresponds to the electronic mail header H, and the electronic mail data MD1 through MD9 correspond to the electronic mail data D1 through D9. Further, the entire mail transmission header MH and the mail transmission data MD1 through MD9 are handled as one electronic mail massage, and the connection is held during this period as shown in (e) of FIG. 3.

In one example of the transmission of the electronic mail, the prescribed data conversion is carried out by using Simple Mail Transfer Protocol (SMTP), which is a basic communication standard. Further, prior to the transmission of the electronic mail transmission header, a communication starting command (for example, HELO command of the SMTP) is transmitted for establishing a connection with the destination, in other words, for starting the communication, and a connection is established with the destination. Then, the electronic mail transmission header MH, and the electronic mail transmission data MD1 through MD9 are transmitted. At the point when the transmission of the electronic mail transmission data MD9 is completed, the connection is ended based on the SMTP (disconnecting operation). A computer program for the parallel process is embedded in the control unit 10 in advance such that the electronic mail transmission header MF and the electronic mail transmission data MD1 through MD9 are transmitted serially each time the corresponding electronic mail header H and the electronic mail data D1 through D9, respectively, are formed.

That is, when the generation of the electronic mail header H is completed, the electronic mail transmission header MH is transmitted, and when the generation of the electronic mail data D1 is completed, the electronic mail transmission data MD1 is transmitted. Then, the electronic mail transmission data is transmitted serially according to the generation of the corresponding electronic mail data. The LANIF 16 operates as the electronic mail transmission function (serial transmission function) that carries out an electronic mail transmission process with the control unit 10. That is, the LANIF 16 carries out an electronic mail transmission process by serially transmitting the electronic mail data for each packet by electronic mail with the control unit 10. Under such a configuration, the transmission of the electronic mail can be carried out in parallel with the original document scanning process, the generation process of the image data, and the generation process of the electronic mail data.

The following functions can be added to the electronic mail transmission process. A determining function can be provided to determine the readiness of the electronic mail data to be transmitted next in the serial electronic mail transmission. In addition, a connection holding function can be provided to transmit to the destination, a connection holding command to hold the connection established with the destination (for example, NO OPeration (NOOP) command of the SMTP) when the determining function determines that the electronic mail to be transmitted next is not ready yet. This function can be realized by embedding a computer program in the LANIF 16 and the control unit 10 or the like in advance. For example, the electronic mail transmission data MD4 cannot be transmitted when the transmission of the electronic mail transmission data MD3 has completed but the scanning process of the second page P2 of the original documents is delayed and the electronic mail data D4 is yet to be generated. In such a case, by operating this function, a connection can be held by transmitting the connection holding command to the destination after the transmission of the electronic mail transmission data MD3, and a transmission error such as a time out can be prevented. A determination timing of the determining function can be set appropriately, and can be executed prior to the transmission of the electronic mail data.

Moreover, the following functions can be added to the electronic mail transmission process. The operation unit 15 can include a function for accepting an instruction from an operator to stop the transmission in the serial electronic mail transmission. In addition, a connection stopping function can be provided to disconnect the connection by transmitting to the destination, a connection stopping command (for example, RSET command or QUIT command of the SMTP), which stops the connection established with the destination when the operation unit 15 accepts an instruction from the operator to stop the transmission. This function can be executed by embedding a computer program in the ROM 18 in advance. The timing to accept the instruction to stop the transmission can be set appropriately, and can be carried out prior to the transmission of the electronic mail data. Further, during the parallel process from the original document scanning process until the electronic mail transmission process of the image data, in other words, during the transmission of the electronic mail data (during one electronic mail transmission process), when accepting an instruction to stop the transmission, the electronic mail data including the already transmitted electronic mail data can be abandoned retroactively by using the communication system specification of the destination as it is.

Furthermore, another function can be provided to stop each of the processes, such as the original document scanning process, the generation process of the image data, and the generation process of the electronic mail data, when accepting an instruction to stop the transmission in the electronic mail transmission process, and to delete various data relating to the original document that is stored in the image memory 20 and other storage devices.

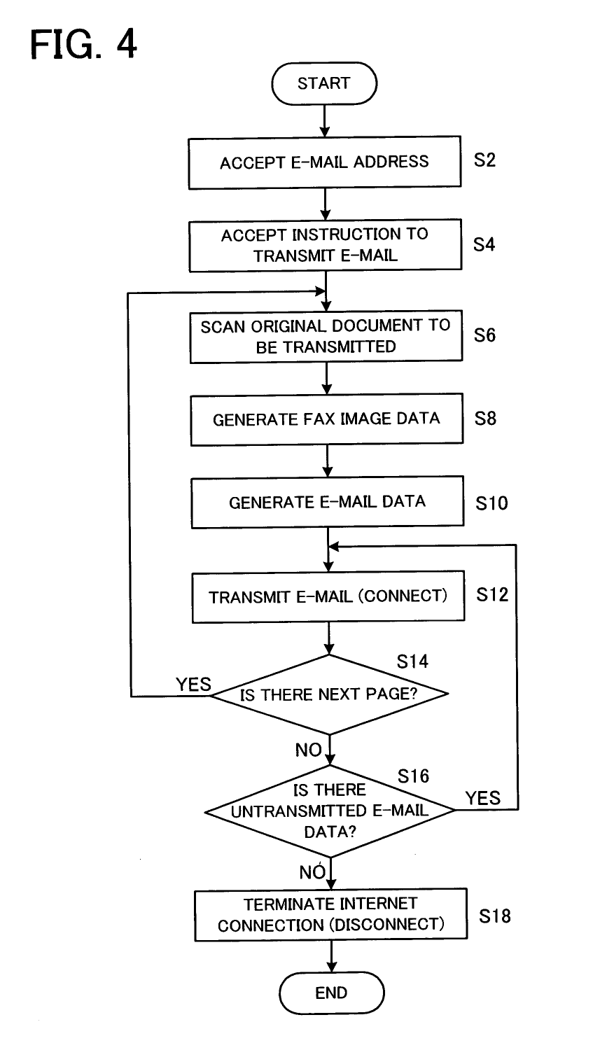

FIG. 4 is a flowchart showing an overview of the operation flow of the facsimile machine according to the present invention. Further, the operation flow is just one example and is not limited to the example shown. Moreover, such an operation flow can be carried out by embedding a computer program in the ROM 18 in advance. First, the operation unit 15 accepts as input the electronic mail address of the destination to which the electronic mail is to be transmitted (step S2). When the electronic mail address of the destination is already registered with the HD 23, a registration list is called, and the electronic mail address can be selected appropriately from the list. Next, the operation unit 15 accepts an instruction to transmit the electronic mail (electronic mail transmission operation) (step S4).

In accordance with the signal from the operation unit 15 that accepted the instruction to transmit the electronic mail, the control unit 10 instructs the scanning unit 12 to scan the original document to be transmitted, and the scanning unit 12 scans the original document, in other words, an original document scanning process is executed (step S6). This original document scanning process is generally carried out as a unit of pages as described above. The FAX image data (image data, in other words, image data for facsimile communication) is generated (image data generation process) by the image data generating function in parallel with the original document scanning process, and the image data is stored in the image memory 20 (step S8). The data conversion method of the image data here is as described above.

In parallel with the scanning process of the original document, the image data that is generated according to the receiving ability of the destination is fetched from the image memory 20 for each packet. The electronic mail data generating function (data converting function) serially generates the electronic mail data for each packet from the fetched image data (serial data conversion into electronic mail data). In other words, an electronic mail data generation process is executed using the fetched image data (step S10). Therefore, the image data is serially converted into electronic mail data in parallel with the original document scanning process.

Prior to the transmission of the electronic mail, a connection is established with the Internet IN (or the LAN) via the LANIF 16, and a communication starting command to start the communication (for example, HELO command of the SMTP) is transmitted to the destination. After a connection is established with the Internet IN, the electronic mail transmission function (serial transmission function) carries out serial electronic mail transmission for each packet, in other words, an electronic mail transmission process, on the serially converted electronic mail data (step S12). Therefore, the electronic mail data is transmitted serially in the form of electronic mail in parallel with the original document scanning process.

In parallel with the original document scanning process, the image data generation process, the electronic mail data generation process, and the electronic mail transmission process are carried out, and it is determined whether or not there is a next page of original documents to be transmitted to confirm the scanning state of the original documents (step S14). When there is a next page, the process returns to step S6, and each processing operation is continued. When there is no next page, it is confirmed whether or not there is untransmitted electronic mail data (step S16). When there is untransmitted electronic mail data, the process returns to step S12, and the electronic mail transmission is continued. When there is no untransmitted electronic mail data, the connection established with the Internet IN is terminated, in other words, the connection is disconnected (step S18). When disconnecting the connection established with the Internet IN, an end command to end the communication (for example, QUIT command of the SMTP) is transmitted to the destination.

It is possible to embed functions other than the functions described above. In this case, a subroutine according to the embedded function can be added to the computer program appropriately.

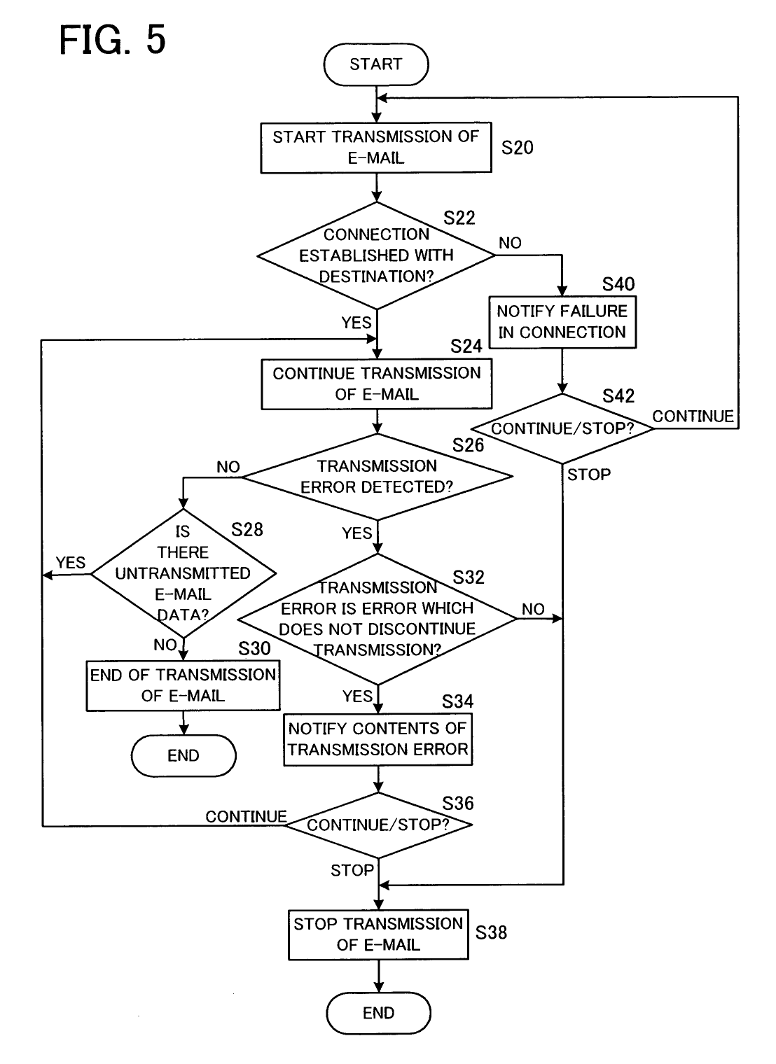

FIG. 5 is a flowchart showing an overview of the function operation flow of the facsimile machine according to the present invention. Further, the operation flow shown in FIG. 5 is just one example, and the invention is not limited to such an example. Moreover, as described above, such an operation flow can be carried out by embedding a computer program in the ROM 18 in advance. Prior to the transmission of the electronic mail, a connection is established with the Internet IN (or LAN) via the LANIF 16. As described above, a communication starting command to start the communication (for example, HELO command of the SMTP) is transmitted to the destination, and the transmission of electronic mail is started (step S20). Next, it is confirmed whether or not a connection succeeded to be established with the destination by using an appropriate command of the SMTP (step S22). When a connection is established with the destination (step S22: YES), the transmission of the electronic mail is continued (step S24).

While the transmission is continued, a transmission error may be detected under an appropriate cycle or by an appropriate command (step S26). When there is no transmission error (step S26: NO), it is confirmed whether or not there is untransmitted electronic mail data (step S28). When there is untransmitted electronic mail data (step S28: YES), the process returns to step S24, and the transmission of the electronic mail is continued. When there is no untransmitted electronic mail data (step S28: NO), the transmission of the electronic mail is ended (step S30). When there is a transmission error (step S26: YES), it is confirmed whether or not the contents of the transmission error correspond to a transmission error that is incapable of continuing the transmission of the electronic mail (step S32).

When the transmission error is an error which does not discontinue the transmission (step S32: YES), the contents of the transmission error are notified by the notifying and selecting function (step S34). Then, it can be selected whether to continue or stop the transmission of the electronic mail (step S36). Further, the transmission error, which can continue the transmission, includes a time out, etc. When it is selected to continue the transmission of the electronic mail (step S36: continue), the process returns to step S24, and the transmission of the electronic mail is continued. When it is selected to stop the transmission of the electronic mail (step S36: stop), the transmission of the electronic mail is stopped (that is, disconnected) (step S38). Further, when stopping the transmission of the electronic mail, a connection stopping command (for example, RSET command or QUIT command of the SMTP) is used appropriately.

When the transmission error is an error incapable of allowing the transmission to continue (step S32: NO), the fact that the transmission of the electronic mail cannot be continued is notified, and the transmission of the electronic mail is stopped (that is, disconnected) forcibly by the transmission stopping function (step S38). Further, the transmission error which is incapable of allowing the transmission to continue the transmission includes a mistake in the input electronic mail address of the destination, a mistake in the input of various configuration items, no input of various configuration items, or the like. During the parallel process from the original document scanning process until the electronic mail transmission process of the image data, in other words, during the transmission of the electronic mail data (one electronic mail transmission process), when accepting an instruction to stop the transmission (step S38), or when stopping the transmission forcibly (step S38), the electronic mail data including the transmitted electronic mail data can be abandoned retroactively by using the communication system specification of the electronic mail of the destination as it is. Further, the operation to stop the transmission (step S38) can be carried out by the transmission stopping function.

A series of flow of steps S26, S32, S34 and S38 is carried out by the notifying and selecting function that is formed appropriately from the computer program that is embedded in the ROM 18 in advance. Moreover, a series of flow of steps S26, S32 and S38 is carried out by the transmission stopping function that is formed appropriately by the computer program embedded in the ROM 18 in advance.

When a connection failed to be established with the destination (step S22: NO), a fact that the connection failed to be established with the destination is notified by the notifying and selecting function (step S40), and it can be selected whether to continue or stop the transmission of the electronic mail (step S42). When it is selected to continue the transmission of the electronic mail (step S42: continue), the process returns to step S20, and the transmission of the electronic mail is started (restarted). When it is selected to stop the transmission of the electronic mail (step S42: stop), the transmission of the electronic mail is stopped (in other words, disconnected) (step S38). For the cases when the connection failed to be established with the destination, for example, there are cases in which the mail server (MS 3A, 3B) is unknown.

An operation to select either continue or stop in the steps S36 and S42 can be carried out appropriately by an input made to the operation unit 15. Moreover, the notification in the steps S34 and S40 can be carried out appropriately by displaying on the display unit 17 or the like. The notification can be carried out by the display and by voice, or just by voice in place of the display. Further, the connection can be disconnected by transmitting to the destination, the connection stopping command to stop the connection established with the destination when the operation unit 15 accepts the instruction to stop the transmission from the operator.

What is claimed is:

1. A facsimile machine comprising:
means for scanning an original document to be transmitted;
means for generating image data for a facsimile communication;
means for serially converting the image data for the facsimile communication into packets as electronic mail data, said converting occurring in parallel with the scanning of the original document; and
means for serially transmitting the electronic mail data in the form of electronic mail for each packet.

2. The facsimile machine according to claim 1, further comprising:
means for generating image data for a facsimile communication according to a receiving ability of a destination by identifying the receiving ability of the destination prior to the scanning of the original document.

3. The facsimile machine according to claim 1, further comprising:
means for determining readiness of electronic mail data to be transmitted next in the serial electronic mail transmission; and
means for transmitting a connection holding command to the destination to hold the connection established with the destination when the means for determining determines that the electronic mail data to be transmitted next is not ready.

4. The facsimile machine according to claim 1, further comprising:
an operation unit which accepts an instruction to stop a transmission in the serial electronic mail transmission; and
means for disconnecting a connection by transmitting to the destination, a connection stopping command to stop the connection established with the destination when the operation unit accepts the instruction to stop the transmission.

5. The facsimile machine according to claim 1, further comprising:
means for notifying and selecting to notify of a fact that a connection failed to be established with the destination and to select either to continue or stop the transmission of the electronic mail, when the connection failed to be established with the destination in the transmission of the electronic mail.

6. The facsimile machine according to claim 5, wherein the means for notifying and selecting notifies of the contents of a transmission error when detecting a transmission error in the transmission of the electronic mail, and selects either to continue or stop the transmission of the electronic mail.

7. The facsimile machine according to claim 5, further comprising:
means for stopping the transmission of the electronic mail by notifying of a fact that the transmission of the electronic mail cannot be continued when a transmission error is detected in the transmission of the electronic mail and the contents of the transmission error correspond to a state in which the transmission of the electronic mail cannot be continued.

8. A facsimile machine comprising:
a scanning unit which scans an original document to be transmitted;
a generating unit which generates image data for a facsimile communication;
a data conversion unit which serially converts the image data for the facsimile communication into packets as electronic mail data in parallel with the scanning of the original document; and
a serial transmission unit which serially transmits the electronic mail data for each packet in a form of electronic mail.

9. The facsimile machine according to claim 8, further comprising:
an image data generating unit which generates image data for facsimile communication according to a receiving ability of a destination by identifying a receiving ability of the destination prior to the scanning of the original document.

10. The facsimile machine according to claim 8, further comprising:
a determining unit which determines readiness of electronic mail data to be transmitted next in the serial electronic mail transmission; and
a connection holding unit which transmits a connection holding command to the destination to hold the connection established with the destination when the determining unit determines that the electronic mail data to be transmitted next is not ready.

11. The facsimile machine according to claim 8, further comprising:
an operation unit which accepts an instruction to stop a transmission in the serial electronic mail transmission; and
a connection stopping unit which disconnects a connection by transmitting to the destination, a connection stopping command to stop the connection established with the destination when the operation unit accepts the instruction to stop the transmission.

12. The facsimile machine according to claim 8, further comprising:
a notifying and selecting unit which notifies of a fact that a connection failed to be established with the destination when the connection failed to be established with the destination in the transmission of the electronic mail, and selects either to continue or stop the transmission of the electronic mail.

13. The facsimile machine according to claim 12, wherein the notifying and selecting unit notifies of contents of a transmission error when detecting a transmission error in the transmission of the electronic mail, and selects either to continue or stop the transmission of the electronic mail.

14. The facsimile machine according to claim 12, further comprising:
a transmission stopping unit which stops a transmission of an electronic mail by notifying of a fact that the transmission of the electronic mail cannot be continued when a transmission error is detected in the transmission of the electronic mail and the contents of the transmission error correspond to a state in which the transmission of the electronic mail cannot be continued.

15. A facsimile transmission method comprising:
scanning an original document to be transmitted;
generating image data for a facsimile communication;
converting the image data for the facsimile communication serially into packets as electronic mail data in parallel with the scanning of the original document; and
transmitting the electronic mail data serially for each packet in a form of electronic mail for each packet.

16. The facsimile transmission method according to claim 15, further comprising:
generating image data for a facsimile communication according to a receiving ability of a destination by identifying a receiving ability of the destination prior to the scanning of the original document.

17. The facsimile transmission method according to claim 15, further comprising:
determining readiness of electronic mail data to be transmitted next in the serial electronic mail transmission; and
transmitting a connection holding command to the destination to hold a connection established with the destination when it is determined that the electronic mail data to be transmitted next is not ready.

18. The facsimile transmission method according to claim 15, further comprising:
accepting an instruction to stop a transmission in the serial electronic mail transmission; and
disconnecting a connection by transmitting to the destination, a connection stopping command to stop the connection established with the destination when accepting the instruction to stop the transmission.

19. The facsimile transmission method according to claim 15, further comprising:
notifying of a fact that a connection failed to be established with the destination when the connection failed to be established with the destination in a transmission of the electronic mail, and selecting either to continue or stop the transmission of the electronic mail.

20. The facsimile transmission method according to claim 19, further comprising:
notifying of contents of a transmission error when detecting a transmission error in the transmission of the electronic mail, and selecting either to continue or stop the transmission of the electronic mail.

21. The facsimile transmission method according to claim 19, further comprising:
stopping the transmission of the electronic mail by notifying of a fact that the transmission of the electronic mail cannot be continued when a transmission error is detected in the transmission of the electronic mail and contents of the transmission error correspond to a state in which the transmission of the electronic mail cannot be continued.
